(19) United States
(12) Patent Application Publication
(10) Pub. No.: US 2005/0169717 A1
(43) Pub. Date: Aug. 4, 2005

(54) Electronic drill depth indicator

(76) Inventor: Grant Andrew Field, Brisbane (AU)

Correspondence Address: MICHAEL BEST & FRIEDRICH, LLP, 100 E WISCONSIN AVENUE, MILWAUKEE, WI, 53202, US

(21) Appl. No.: 11/016,083

(22) Filed: Dec. 17, 2004

Related U.S. Application Data
(60) Provisional application No. 60/541,803, filed on Feb. 3, 2004.

(51) Int. Cl. B23B 39/06

(52) U.S. Cl. 408/13; 408/16

(57) ABSTRACT

A system for determining a depth of a hole drilled by a drilling machine. The system can include a drill string including one or more drill rods, wherein each of the one or more drill rods has a length; a target; a laser range finder configured to determine a plurality of distance readings, wherein each of the plurality of distance readings includes a distance value between the laser range finder and the target; and a controller configured to obtain the plurality of distance readings from the laser range finder. The controller processes the plurality of distance readings to produce a calculated distance between the laser range finder and the target. The controller may also use the calculated distance and the length of each of the one or more drill rods included in the drill string to determine the depth of the hole drilled by the drilling machine.

### RELATED APPLICATIONS

The present application claims priority to U.S. provisional patent application Ser. No. 60/541,903 titled “ELECTRONIC DRILL DEPTH INDICATOR,” filed on Feb. 3, 2004.

### FIELD OF THE INVENTION

The invention relates to drilling machines, and more particularly, to drilling machines having electronic drill depth indicators.

### BACKGROUND OF THE INVENTION

Drilling machines typically have a frame, a deck, a tower, and a rotary head. The frame is supported for movement over the ground, and the tower is mounted on the frame. The deck is supported by the frame and has a generally horizontal upper surface with an opening through which a drill rod is extendable. The rotary head moves along the tower and engages with a drill rod. When the drill rod is engaged with the rotary head, the drill rod rotates with the rotary head. A feed system can control the movement of the rotary head along the tower. The feed system can force the rotary head downward to cause the drill rod to penetrate the ground and create a drilled hole. Typical drilling machines are capable of drilling to depths greater than the length of a single drill rod by connecting multiple drill rods together to create a drill string.

### SUMMARY OF THE INVENTION

Traditionally, drilling machines have used rotary pulse encoders to measure rotary head displacement, which is used in combination with the number of drill rods connected in the drill string to compute the depth of the drilled hole. The encoder is driven mechanically by a rotating function of the feed system, These devices are inherently unreliable and they are difficult to assemble in a standardized fashion onto drilling machines because drilling machine feed systems can take a variety of forms. Each drilling machine can have a different feed system that requires its own individual design of the encoder drive mechanism.

Instead of using a rotary pulse encoder, embodiments of the invention use an electronic drill depth indicator that includes a laser range finder configured to sense the position of the rotary head relative to the top of the tower. A controller reads a signal from the laser range finder and computes the depth of the drilled hole based on the signal from the laser range finder and the number of drill rods in the current drill string.

Some embodiments of the invention can be designed in a manner for ease of integration into existing and new machines. Some other embodiments of the invention can be sold as an easily installed and calibrated after-market product. Still other embodiments of the present invention can be integrated into a complete control system for a new product, such as a drilling machine. In other embodiments, the invention can be a plug-in module to a preexisting control system.

Additional embodiments provide a system for determining a depth of a hole drilled by a drilling machine. The system can include a drill string including one or more drill rods, wherein each of the one or more drill rods has a length; a target; and a laser range finder configured to determine a plurality of distance readings. Each of the plurality of distance readings includes a distance value between the laser range finder and the target. The system can also include a controller configured to obtain the plurality of distance readings from the laser range finder, to process the plurality of distance readings to produce a calculated distance between the laser range finder and the target, and to use the calculated distance and the length of each of the one or more drill rods in the drill string to determine the depth of the hole drilled by the drilling machine.

Another embodiment can provide a method for determining a depth of a hole drilled by a drilling machine. The method can include obtaining a plurality of distance readings from a laser range finder, each of the distance readings including a distance value between the laser range finder and a rotary head of the drilling machine; processing the plurality of distance readings to produce a calculated distance between the laser range finder and the rotary head of the drilling machine; and using the calculated distance and the length of a drill string of the drilling machine to determine the depth of the hole drilled by the drilling machine.

Yet another embodiment provides a controller for a drilling machine. The controller can include a laser range finder interface, a stop-count-logic-in module, a carousel-logic-in/out module, a deceleration-logic module, a target-depth-logic-out module, a rod support logic-in/out module, and a pipe-in-the-hole-logic-out module.

Additional embodiments can provide a computer-readable medium including instructions for determining a depth of a hole drilled by a drilling machine. The computer-readable medium can include instructions for obtaining a plurality of distance readings from a laser range finder, each of the plurality of distance readings including a distance value between the laser range finder and a rotary head of the drilling machine; processing the plurality of distance readings to produce a calculated distance between the laser range finder and the rotary head of the drilling machine; and using the calculated distance and the length of a drill string of the drilling machine to determine the depth of the hole drilled by the drilling machine.

Another embodiment can provide a method of calibrating a laser range finder for a drilling machine. The method can include attaching the laser range finder to the drilling machine, aiming the laser range finder at a rotary head of the drilling machine, placing the rotary head of the drilling machine at a predetermined position, signaling the laser range finder that the rotary head is at the predetermined position, and calibrating the laser range finder with the rotary head at the predetermined position.

Other features and advantages of the invention will become apparent to those skilled in the art upon review of the detailed description, claims, and drawings.

### BRIEF DESCRIPTION OF THE DRAWINGS

In the drawings:

FIG. 1 is a schematic illustration of an exemplary drilling system.

FIG. 2 is a schematic illustration of an exemplary drill controller.

FIG. 3 is a flow chart illustrating an exemplary distance determination process.

FIG. 4 is a flow chart illustrating an exemplary calibration process.

### DETAILED DESCRIPTION

Before embodiments of the invention are described, it is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

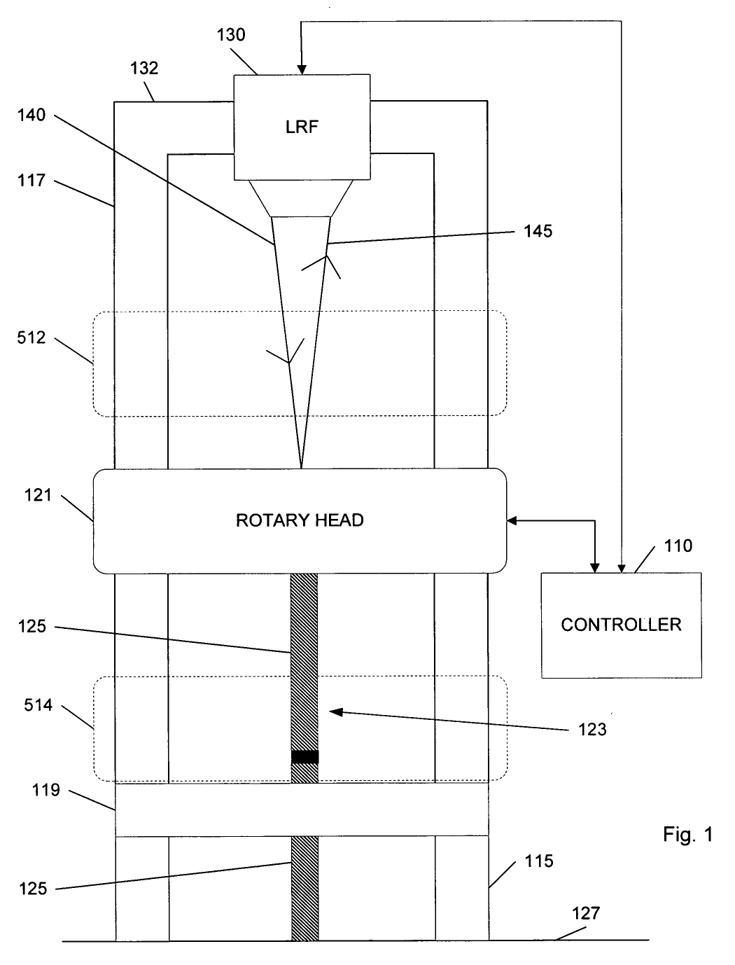

FIG. 1 illustrates an exemplary drilling system 100. The drilling system 100 includes a drilling machine 105 and a counter or controller 110. The drilling machine 105 includes a frame 115 that supports a tower 117 and a deck 119. The drilling machine 105 further includes a rotary head 121 that engages with a drill string 123. The drill string 123 can include one or more drill rods 125. The drill string 123 extends through a hole (not shown) in the deck 119 and makes contact with a surface 127. In some embodiments, the rotary head 121 causes the drill string 123 to rotate and bore a hole in the surface 127. The rotary head 121 can also move along the tower 117 to further penetrate the surface 127 with the drill string 123. In some embodiments, the movement of the rotary head 121 along the tower 117 is controlled by a feed system (not shown).

The drilling machine 105 also includes a laser range finder (“LRF”) 130. The LRF 130 can be mounted to a top portion 132 of the tower 117 and aimed at the top of the rotary head 121. The LRF 130 can sense a distance between the LRF 130 and the rotary head 121. The LRF 130 can include a laser distance measuring (“LDM”) module (not shown). The LDM module may be or may include an LDM 40A LRF manufactured by ASTECH Angewandte Sensortechnik GmbH that provides opto-electronic distance measuring.

In some embodiments, the LRF 130 can operate without the use of specially placed reflectors or mirrors. The LRF 130 can be operable to sense a beam reflected from the natural surface of a target. The LRF 130 can also provide a visible red laser beam that enables easy sighting and alignment.

The LRF 130 can be a class 2 laser. Class 2 lasers emit light that is in the visible light spectrum and are safe enough such that the natural blink aversion of a human eye provides safe eye protection. The LRF 130 can also be ruggedized such that it meets the Internal Protection (“IP”) 65 standard for industrial use. In particular, the LRF 130 can be dust-proof and waterproof or liquid-proof. The LRF 130 can also be mounted in an enclosure, such as Perspex™ window, to provide increased protection from environmental contaminants.

In some embodiments, the LRF 130 determines a distance by emitting a modulated laser light that is diffusely reflected back from the target. As illustrated in FIG. 1, the LRF 130 transmits a reference beam or ray 140 toward the rotary head 121 and receives a return beam or ray 145 reflected from the rotary head 121. The LRF 130 senses the reflected ray 145 and compares the reflected light to the reference ray 140 or another reference light signal to determine a difference in phase. The amount of phase shift can then be used to determine a distance to the top of the rotary head 121. In some embodiments, a phase shift can be translated to a distance within approximately I centimeter of the true distance between the LRF 130 and the rotary head 121.

The LRF 130 can also use a time difference to determine a distance between the LRF 130 and the rotary head 121. In some embodiments, the LRF 130 transmits the reference ray 140 at a first time and senses the return ray 145 at a second time. The LRF 130 determines a difference between the first time and the second time and translates the time difference into a distance between the LRF 130 and the rotary head 121. It should be understood that the LRF 13 can determine a time difference between the reference ray 140 and the return ray 145 in addition to or in place of determining a phase shift between the reference ray 140 and the return ray 145. In some embodiments, using both a phase shift and a time difference can generate a determined distance that is closer to the true distance between the LRF 130 and the rotary head 121. It should also be understood that dust or debris in the air can affect the operational accuracy of the LRF 130. The distance and angle between the LRF 130 and the top of the rotary head 121 and the surface properties and movement of the rotary head 121 can also affect the operational accuracy of the LRF 130.

The distance determination can also be performed by a device external to the LRF 130. For example, the controller 110 can receive the time difference and/or phase shift and determine a distance from the received data. The controller 110 can also receive raw data from the LRF 130. Raw data can include properties of the reference ray 140 and the return ray 145, such as transmission time, sensed time, initial phase, sensed phase, and the like. The controller 110 can use the raw data to determine the time difference and/or phase shift between the rays 140 and 145 and consequently, determine the distance between the LRF 130 and the rotary head 121.

The controller 110 controls the operation of the drilling machine 105. In some embodiments, the controller 110 regulates the rotational speed of the drill string 123 initiated by the rotary head 121. The controller 110 can also control movement of the rotary head 121 along the tower 117. In some embodiments, the controller 110 can be part of a cab or operator panel of a central control system for the drilling system 100. The controller 110 can also be part of a central control system for multiple drilling systems 100. In some embodiments, the controller 110 and/or a operator panel containing the controller 110 is also ruggedized to receive an IP 65 durability rating indicating that it can withstand dust and water or other contaminants present in a drilling environment.

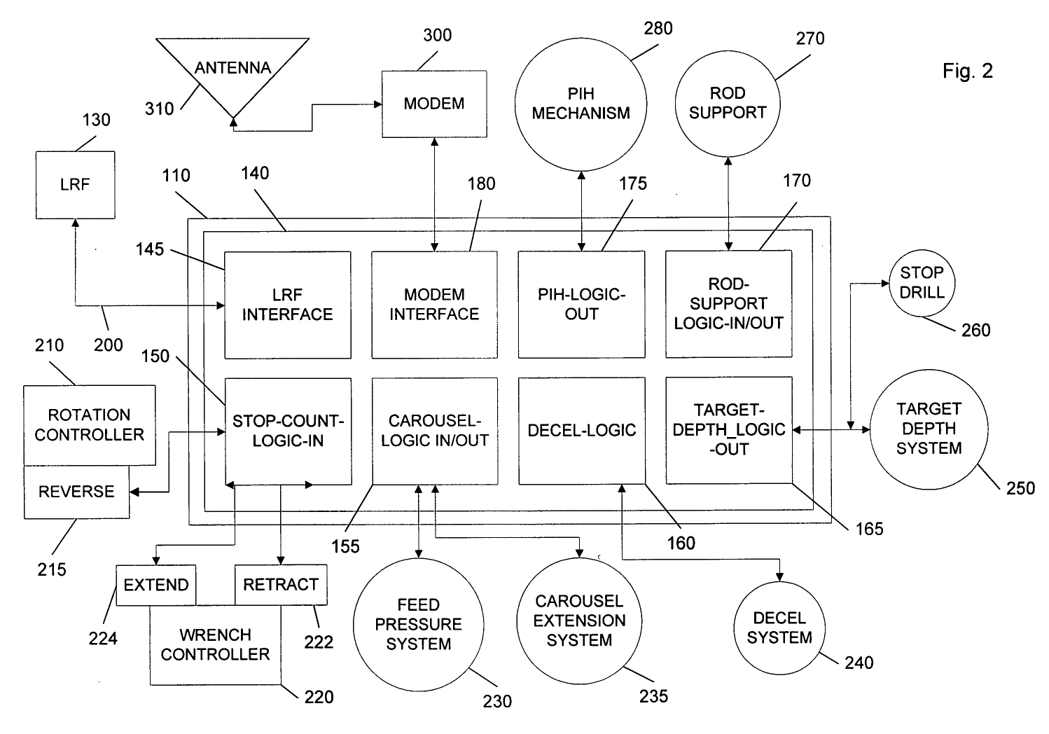

FIG. 2 illustrates the controller 110 according to one embodiment of the invention. In some embodiments, the controller 110 includes an operator controlled programmable logic controller (“OPLC”) 140. In some embodiments, the OPLC 140 includes an Unitronix V120-12-R1 device with a built-in graphical display. The Unitronix V120-12-R1 device can provide simple installation with minimal wiring requirements and can be programmed during manufacturing to “switch on and use” after installation. Specific operations of the controller 110, such as logic associated with drill rod start/stop count, pipe-in-the-hole (“PIH”) determination, and rod support lock-out, can be programmed into the OPLC 140 as described below.

The V-120 family of OPLC's can provide various functionality such as a PID loop controller module, an input module (digital and analog), an output module (digital and analog), a thermocouple module, a shaft encoder module, and a modem interface module that can enable the functionality of the system 100 to be expanded as needs arise. Using the modules listed above and/or other available modules, the OPLC 130 can provide a global system for mobile communications (“GSM”) modem for remote communications, fan control, compressor control, a drill monitoring system control, generator control, auto level control, data logging, and/or time keeping.

As seen in FIG. 2, the OPCL 140 can include a laser range finder (“LRF”) interface 145, a stop-count-logic-in module 150, a carousel-logic-in/out module 155, a deceleration-logic (“decal-logic”) module 160, a target-depth-logic-out module 165, a rod-support-logic-in/out module 170, a pipe-in-the-hole (“PIH”) logic-out module 175, and a modem interface 180. It should be understood that the OPLC 140 can also include additional components. The OPLC 140 can also include a subset of the components listed above and the functionality provided by the components can be combined in various ways. The components listed above can also be included in the controller 110 separately from the OPLC 140.

The LRF interface 145 can be configured to communicate with the LRF 130. In some embodiments, the LRF 130 transmits signals to the LRF interface 145 over a connection 200. The LRF 130 can transmit analog 4-20 milliamp (“mA”) signals. The LRF 130 can also communicate with the LRF interface 145 using a communication protocol such as RS232, RS422, or RS485. In some embodiments, the LRF 130 and LRF interface 145 communicate using the RS485 protocol due to the length or distance of the connection 200 and/or for compatibility desired with other standardized communication protocols used by the OPLC 140 or controller 110.

The LRF interface 145 can be configured to receive distances between the LRF 130 and the rotary head 121. As described above, the LRF interface 145 can also be configured to receive time difference data and/or phase shift data from the LRF 130 and to determine a distance from the received data. Furthermore, the LRF interface 145 can also receive raw data from the LRF 130 and can use the raw data to determine the time difference data and/or phase shift data and determine a distance between the LRF 130 and the rotary head 121 from the data. In some embodiments, the LRF interface 145 processes the data transmitted by the LRF 130 as described below.

In addition to determining the distance between the LRF 130 and the rotary head 121, the OPLC 140 can determine the length of the drill string 123 to determine a depth of a drilled hole. In multi-pass drilling machines, drill rods 125 can be added and removed from the drill string 123 to increase and decrease the length of the drill string 123. The OPLC 140 can determine drill string 123 length by tracking the drill rods 125 as they are added to and removed from the drill string 123. To add a drill rod 125, a wrench (not shown) is extended to hold the top of the current drill string 123. Once the drill string 123 is supported by the wrench, the rotary head 121 can be reversed (i.e., unthreaded from the drill string 123 and raised) to allow room for a drill rod 125 to be added between the rotary head 121 and the top of the current drill string 123. The additional drill rod 125 is engaged with the rotary head 121 and the current drill string 123 supported by the wrench. Once the additional drill rod 125 is engaged, the wrench can be retracted since the rotary head 121 supports the entire drill string.

To remove drill rods 125, the wrench may hold the drill string 123 beginning at a drill rod 125 one below the top drill rod 125 of the drill string 123. With the wrench supporting a portion of the drill string 123, the top drill rod between the rotary head 121 and the portion of the drill string 123 supported by the wrench can be removed. Once the top drill rod 125 is removed there is a gap between the rotary head 121 and the remaining portion of the drill string 123. To engage the rotary head 121 to the remaining portion of the drill string 123, the rotary head 121 can be lowered and engaged with the remaining portion of the drill string 123 supported by the wrench. Once the rotary head 121 is engaged with the drill string 123, the wrench can be retracted.

Traditionally, a switch is positioned on the wrench to indicate whether the wrench was extended and engaged with the drill string 123. The state of the switch was used to determine whether drills rods 125 were being added or removed. The switch could be easily damaged, however, during the operation of the drilling machine 105.

Rather than sensing mechanical switches on the wrench, the OPLC 140 can sense actions initiated by an operator through controllers for the wrench and the rotary head 121. As illustrated in FIG. 2, the stop-count-logic-in module 150 can receive data from a rotation controller 210. The rotation controller 210 can include a reverse output 215 that can be read to determine if the rotary head 121 is rotating in reverse (unthreading) as requested by an operator. In some embodiments, the rotation controller 210 can also provide data indicating if the rotary head 121 is moving away from the top of the drill string 123.

The stop-count-logic-in module 150 can also receive data from a wrench controller 220. In some embodiments, the wrench controller 220 includes a retract output 222 and an extend output 224. The retract output 222 and the extend output 224 can be processed to determine if the wrench is retracted or if the wrench is extended and engaged with the drill string 123 respectively, as initiated by an operator of the wrench controller 220.

To determine if a drill rod 125 is added or removed, the stop-count-logic-in module 150 can determine if the wrench is retracted or extended and if the rotary head 121 is reversing or not. In some embodiments, if the wrench is extended and the rotary head 121 is reversing, the OPLC 140 can determine that the number or count of drill rods 125 is changing and a stop count flag can be generated. Also, if the wrench is retracted the OPLC 140 can determine that the number or count of drill rods 125 is constant and a resume count flag can be generated.

In some embodiments, the reverse output 215 of the rotation controller 210 and the retract output 222 and the extend output 224 of the wrench controller 220 can be wired to the stop-count-logic-in module 150, and the internal logic of the OPLC 140 can determine when a stop count flag and a resume count flag can be generated. In some embodiments, the stop-count-logic-in module 150 includes an “AND” gate to determine if the two logic steps necessary for generating a stop count flag are present at approximately the same time.

When the OPLC 140 knows the length of the drill string 123 and the distance between the LRF 130 and the top of the rotary head 121, the OPLC 140 can determine the depth of a hole drilled by the drilling machine 105. In some embodiments, the OPLC 140 and LRF 130 can accurately determine the position of the rotary head 121 with software enabled logic and can eliminate most, if not all switches from the tower 117. This can provide manufacturing cost savings, plus simplify wiring and in-field fault finding of complex mechanical switching and relays. In addition to the depth of a hole drilled by the drilling machine 105, the OPLC 140 can determine a drilling rate. The OPLC 140 can also allow an operator to specify measurement units, such as feet per hour, inches per minute, miles per month, etc. The OPLC 140 can also include an accumulator for recording the total drilled distance between resets that can occur between shifts.

The carousel-logic-in/out module 155 can control operation of a rotary magazine or carousel (not shown). The carousel can hold drill rods 125 to be added to the drill string 123 or removed from the drill string 123. In some embodiments, the carousel can be extended to place a drill rod 125 held by the carousel between the rotary head 121 and the top of the current drill string 123.

The carousel-logic-in/out module 155 can communicate with a feed pressure system 230 and a carousel extension system 235 to determine when the carousel is extended. The carousel-logic-in/out module 155 can also control feed pressure when the carousel is extended out from the stowed position.

In some embodiments, the carousel-logic-in/out module 155 can also limit the extension of the carousel. For example, based on the data received from the LRF 130, the OPLC 140 can determine that the rotary head 121 is in a position that does not accommodate the extension of the carousel. The extension of the carousel can damage the carousel, the rotary head 121, or other components of the drilling machine 105. In some embodiments, the carousel-logic-in/out module 155 communicates with the feed pressure system 230 and/or the carousel extension system 235 to regulate when the carousel is extended and when drill rods 125 are added and/or removed from the drill string 123.

The decel-logic module 160 can provide a deceleration feature for the rotary head 121. The decel-logic module 160 can include deceleration software settings that process data transmitted by the LRF 130. If the data from the LRF 130 indicates acceleration of the rotary head 121 at a rate faster than the software settings, the decel-logic module 160 can trigger a de-stroke command to the deceleration (“decel”) feed pump or system 240 of the rotary head 121.

The target-depth-logic-out module 165 can be programmed to control drilling functions to limit the depth of the hole once the indicated target depth has been reached. In some embodiments, the OPLC 140 can have an operator input or interface to obtain a desired hole depth. The target-depth-logic-out module 165 can be programmed so that when the desired programmed indication (depth) is achieved, it can actuate an internal relay to sound an alarm and/or generate a graphic on a target depth system or interface 250 that indicates “target depth reached.” The target-depth-logic-out module 165 can also be programmed to control drilling functions to limit the depth of the hole once the indicated target depth has been reached. In some embodiments, once the target depth is reached, as determined by the OPLC 140 based on data provided by the LRF 130, an internal relay can activate a stop-drill mechanism 260 that can control feed and rotation controller power supply.

The rod-support-logic-in/out module 170 can provide an interlocking function for a rod support 270. The rod support 270 can include a rod or mechanical arm, such as the carousel, that can be moved or extended toward the drilling machine 105. In some embodiments, the extension of a rod can interfere with the movement of the rotary head 121 and can damage the rotary head 121 or the rod. In some embodiments, the rod-support-logic-in/out module 170 can provide automatic interlock for the rod support. The rod-support-logic-in/out module 170 can use the distance determined by the LRF 130 and, if an extended rod is in the way of the rotary head, the rod-support-logic-in/out module 170 can swing or move the rod out of the way of the rotary head 121. The rod-support-logic-in/out module 170 can also cause the rotary head 121 to stop moving if an extended rod is in the way. The LRF 130 can also include alarm functionality if it senses an extended rod that may interfere with the rotary head 121. In some embodiments, the rod-support-logic-in/out module 170 provides safety back up for the alarm functionality of the LRF 130.

Once the OPLC 140 determines the depth of the hole drilled by the drilling machine 105, the OPLC 140 can also determine a pipe-in-hole (“PIH”) condition. The PIH-logic-out module 175 can provide a safeguard to ensure that the drilling machine 105 cannot be moved when the one or more drill rods 125 are still in the hole. In some embodiments, the drilling machine 105 includes wheels or tracks that allow the drilling machine to be moved over the surface 127. Moving the drilling machine 105 with one or more drill rods 125 in the hole can bend and damage the drill rods 125. The PIH-logic-out module 175 can include a clearance value that specifies a minimum distance that the drill string 123 must have out of the hole before movement of the drilling machine 105 is permitted. In some embodiments, the clearance value is 0.3 meters. In some embodiments, the PIH-logic-out module 175 can communicate with a PIH mechanism 280. The PIH mechanism 280 can control power or operation of a jack controller and/or tower controller that can be operated to move the drilling machine 105. The PIH-logic-out module 175 can use the distance determined by the LRF 130 and the clearance value to communicate with the PIH mechanism 280 to disable operation of the jack controller and/or tower controller and permit the drilling machine 105 from moving while a pipe or drill rod is in the hole.

The modem interface 180 can provide a interface to a modem 300 that allows data and signals sent, received, and processed by the OPLC 140 to be sent over a network such as a local area network (LAN) or the Internet. In some embodiments, the modem 300 can transmit data using an antenna 310.

The system 100 can be designed so that should any component fail in the system 100, the drilling machine 105 is not rendered inoperable. This can improve productivity of drilling machines 105 in the field where faulty interlocking and the limited ability to find faults in complex interlocking systems, is responsible for a high percentage of drilling machine 105 downtime. In the case of a failure, the onus can be on the operator to not damage the drilling machine 105 by incorrect operation (i.e., not running the rotary head into the rod support, etc.).

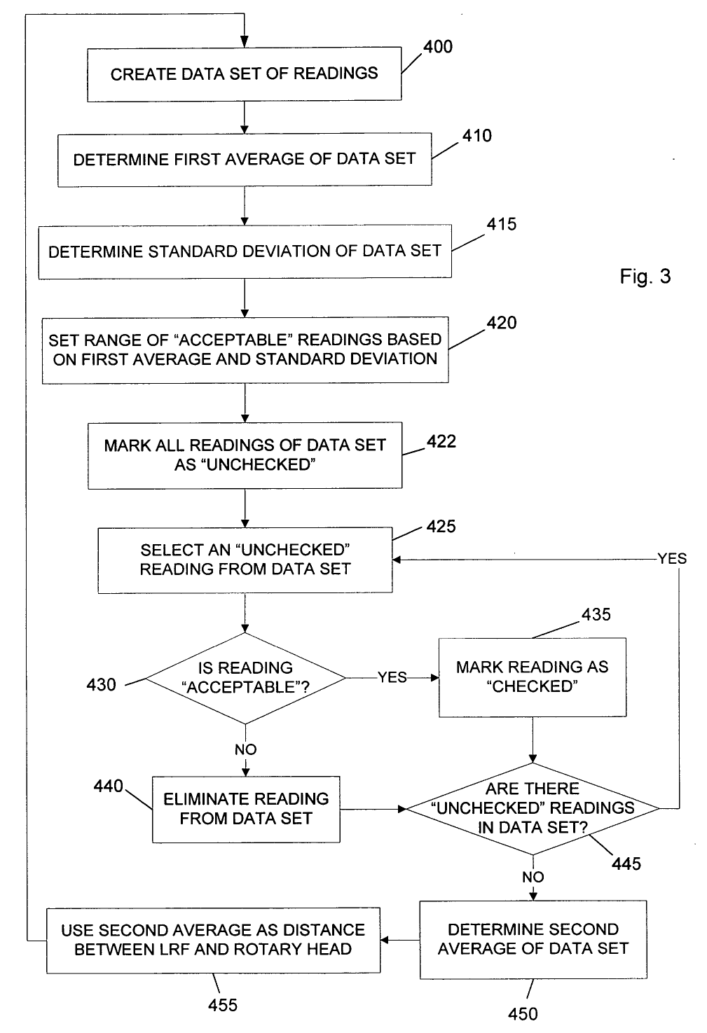

FIG. 3 illustrates an exemplary process executed by the controller 110 to determine a distance between the LRF 130 and the rotary head 121 based on the data transmitted by the LRF 130. The process steps illustrated in FIG. 3 are exemplary in order and content, and the distance determination process can be accomplished with a subset of the depicted steps or additional and alternative steps. It should also be understood that the process depicted in FIG. 3 can be executed by the LRF 130, the LRF interface 145, a separate processing component of the OPLC 140 or the controller 110, or a combination thereof.

When operating the drilling machine 105 with the LRF 130, as illustrated in FIG. 1, the LRF 130 is aimed at the top of a rotary head 121 to determine a distance to the top of the rotary head 121 from the LRF 130. The LRF 130 transmits the transmitted ray 140 and senses the returned ray 145. The LRF 130 uses characteristics of the transmitted ray 140 and the returned ray 145 to determine a distance between the LRF 130 and the top of the rotary head 121. As previously described, the LRF 130 can determine a time difference between the transmitted ray 140 and the returned ray 145 and can use the time difference to determine a distance to the top of the rotary head 121. The LRF 130 can also use a phase shift between the transmitted ray 140 and the returned ray 145 to determine a distance between the LRF 130 and the top of the rotary head 121.

In some embodiments, the LRF 130 outputs a set of distance readings to the controller 110. The LRF 130 can generate one hundred distance readings every second (“100 Hertz”). Each distinct reading can include a determined distance value that specifies a determined distance between the LRF 130 and the top of the rotary head 121. In some embodiments, the distance readings can include additional information such as a timestamp, and determined error threshold, and the like.

As previously described, communications between the LRF 130 and the controller 110 can be via analog 4-20 milliamp signals or more sophisticated communications protocols such as RS232, 422, 485. In some embodiments, RS 485 can be used to account for the length of cable the distance readings travel and the compatibility desired with other standardized communication protocols.

The controller 110 uses the distance readings transmitted by the LRF 130 to determine a depth of a hole drilled by the drilling machine. The controller 110 can increase the accuracy of the determined depth of a drilled hole by mathematically processing the distance readings provided by the LRF 130. In some embodiments, to begin the process of determining a distance between the LRF 130 and the rotary head 121, the controller 110 collects the distance readings received from the LRF 130 every second (one hundred readings) into a data set (step 400). After the LRF 130 creates a set of readings from the LRF 130, the controller 110 can determine a first average of the data set at step 410.

After calculating the first average, the controller 110 can determine a standard deviation of the data set (step 415). In some embodiments, the controller 110 uses the standard deviation to create a range of “acceptable” readings based on the first average and the standard deviation (step 420). Distance readings included in the set that fall outside of the range of acceptable readings can be eliminated from the data set to reduce extreme readings from the LRF 130 that can be erroneous. In some embodiments, the acceptable range can be produced by adding a first multiple of the standard deviation of the data set to the first average to determine a first limit for the range and by subtracting a second multiple of the standard deviation of the data set from the average to determine a second limit for the range. It should be understood that the first multiple and the second multiple can be the same multiple or can be different multiples.

After determining an acceptable range of distance values, the controller 110 processes each reading in the data set to determine if it within an acceptable range set by the controller 110. At step 422, the controller 110 marks all the readings of the data set as “unchecked.” An unchecked reading can include a reading that has not been evaluated against the acceptable range.

At step 425, the controller 110 selects an “unchecked” reading from the data set. Once the controller 110 has selected an unchecked reading from the data set, the controller 110 determines if the selected reading is acceptable (step 430). In some embodiments, the controller 110 determines if the selected reading is acceptable by determining if the reading falls within the acceptable range set by the controller 110. If the controller 110 determines that the selected reading is acceptable, the controller 110 marks the reading as checked at step 435. Marking a reading as checked can include setting a flag associated with the setting, increasing a counter that specifies a number of readings already checked, adding the reading to an accepted subset and removing the reading from the first data set, or the like.

If, however, the selected reading does not fall within the acceptable range, the controller 110 can eliminate the reading from the data set (step 440). Eliminating the reading from the set can include setting a flag associated with the settings, removing the reading from the data set, or the like.

After marking the selected reading as acceptable or eliminating the reading from the data set, the controller 110 determines if there are distance readings of the data set yet to be checked (step 445). As previously described, unchecked readings can be marked by a flag associated with readings, a counter set to the number of readings already checked, or readings remaining in the data set. If unchecked readings remain, the controller 110 returns to step 425 to select another unchecked reading.

If, on the other hand, all the readings of the data set have been checked, the controller 110 determines a second average of the acceptable readings of the data set (step 450). The controller 110 then uses the second average as a distance between the LRF 130 and the rotary head 121 (step 455). In some embodiments, statistically averaging the distance readings from the LRF 130 increases the accuracy of the readings by approximately 10%. In some embodiments, the LRF 130 generates distance readings within approximately 1 cm of the true distance and statistically averaging the readings by the controller 110 brings the readings to within approximately 3 millimeters of the true distance.

After determining the second average, the controller 110 can return to step 400 to create another set of readings from the LRF 130.

It should be understood that the controller 110 can also statistically average raw data, time differentials, and/or phase shifts received from the LRF 130 rather than distance readings. In some embodiments, the controller 110 can statistically average raw data, determine a time differential and/or a phase shift, and determine a distance between the LRF 130 and the top of the rotary head 121 from the determined time differential and/or phase shift. The controller 110 can also statistically average time differentials and/or phase shifts to determine an average time differential and/or phase shift and use the average time differential and/or phase shift to determine a distance between the LRF 130 and the top of the rotary head 121.

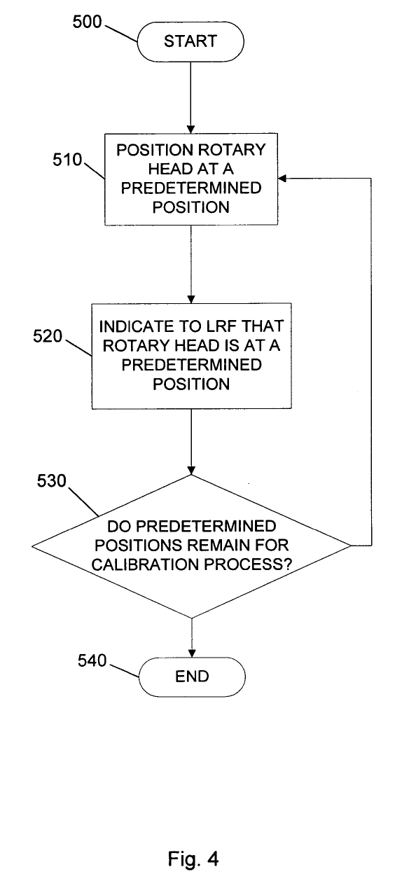

The LRF 130 can also be portable in the sense that it can be moved from one drill to another drill. In some embodiments, the LRF 130 can be generically applied to all drill types that provide a suitable mounting for the LRF 130 and a target. The LRF 130 can also provide a simple and/or quick calibration process such that the LRF 130 can be transferred from one drill to another quickly and correctly. In some embodiments, the calibration process can include transmitting a first ray to a target and sensing a return ray from the target when the target is at one of two extreme positions or a set of predetermined positions. FIG. 4 illustrates an exemplary calibration process beginning at step 500.

In some embodiments, an operator initiates the calibration process by pressing a button, changing the position of a lever or switch, or using another selection mechanism of the controller 110. After initiating the calibration process, the controller 110 communicates with the feed system of the rotary head 121 to position the rotary head 121 at a predetermined position (step 510). A predetermined position can include a top position of the rotary head 121 where it is closest to the LRF 130. A predetermined position can also include a bottom position of the rotary head 121 where it is furthest from the LRF 130. An exemplary top position 512 and bottom position 514 of the rotary head 121 are illustrated in phantom in FIG. 1.

A predetermined position can further include one of infinite positions of the rotary head 121 between the top position and the bottom position. At step 520, the controller 110 signals or indicates to the LRF 130 that the rotary head 121 is at a predetermined position. In some embodiments, an operator initiates the signal to the LRF 130 by selecting a button, switch, or lever on the LRF 130 or the controller 110. In some embodiments, the controller 110 can also signal the LRF 130 by holding the rotary head 121 in a predetermined position for a given amount of time. The controller 110 can also provide the LRF 130 or the controller 110 with a known distance between the rotary head 121 and the LRF 130 when the rotary head 121 is at a predetermined position. In some embodiments, the known position is provided to the controller 110 by an operator. The LRF 130 can use known distances to further calibrate itself by making a determined distance calculated by the LRF 130 generally equal to the known distance.

After indicating to the LRF 130 that the rotary head 121 is at a predetermined position, the controller 110 determines if additional predetermined positions remain for the calibration process (step 530). In some embodiments, an operator provides the controller with predetermined positions for the rotary head 121. The controller 110 can also be programmed with default predetermined positions. If additional predetermined positions remain, the controller 110 returns to step 510 and positions the rotary head 121 at another predetermined position. If additional predetermined positions do not remain, the calibration process is complete (step 540).

In some embodiments, the total time for calibrating the LRF 130 can be approximately the time it takes the rotary head 121 to travel between its extreme positions, or generally 30 to 60 seconds depending on the characteristics of the drilling machine 105. The above calibration process allows the LRF 130 to be moved from one drilling machine to another quickly and efficiently.

Various features and advantages of the invention are set forth in the following claims.

1. A system for determining a depth of a hole drilled by a drilling machine, the system comprising:
a drill string including one or more drill rods, wherein each of the one or more drill rods has a length;
a target;
a laser range finder configured to determine a plurality of distance readings, wherein each of the plurality of distance readings includes a distance value between the laser range finder and the target; and
a controller configured to obtain the plurality of distance readings from the laser range finder, to process the plurality of distance readings to produce a calculated distance between the laser range finder and the target, and to use the calculated distance and the length of each of the one or more drill rods included in the drill string to determine the depth of the hole drilled by the drilling machine.

2. A system as claimed in claim 1, wherein the target includes a rotary head of the drilling machine.

3. A system as claimed in claim 1, wherein the laser range finder includes a Class 2 laser.

4. A system as claimed in claim 1, wherein the controller includes an operator controlled programmable logic controller.

5. A system as claimed in claim 1, wherein the laser range finder is further configured to transmit the plurality of distance readings to the controller using a 4-20 milliamp protocol.

6. A system as claimed in claim 1, wherein the laser range finder is further configured to transmit the plurality of distance readings to the controller using a RS232 protocol.

7. A system as claimed in claim 1, wherein the laser range finder is further configured to transmit the plurality of distance readings to the controller using a RS422 protocol.

8. A system as claimed in claim 1, wherein the laser range finder is further configured to transmit the plurality of distance readings to the controller using a RS485 protocol.

9. A system as claimed in claim 1, wherein the controller is further configured to determine a number of drill rods included in the drill string.

10. A system as claimed in claim 1, wherein the controller is further configured to determine a first average of the plurality of distance readings.

11. A system as claimed in claim 10, wherein the controller is further configured to determine a standard deviation of the plurality of distance readings.

12. A system as claimed in claim 11, wherein the controller is further configured to determine a range of acceptable distance values based on the first average and the standard deviation.

13. A system as claimed in claim 12, wherein the controller is further configured to determine a subset of the plurality of distance readings, the subset including distance readings that include a distance value in the range of acceptable distance values.

14. A system as claimed in claim 13, wherein the controller is further configured to determine a second average of the subset.

15. A system as claimed in claim 14, wherein the controller is further configured to use the second average to determine the calculated distance.

16. A method of determining a depth of a hole drilled by a drilling machine, the method comprising:
obtaining a plurality of distance readings from a laser range finder, each of the plurality of distance readings including a distance value between the laser range finder and a rotary head of the drilling machine;
processing the plurality of distance readings to produce a calculated distance between the laser range finder and the rotary head of the drilling machine; and
using the calculated distance and the length of a drill string of the drilling machine to determine the depth of the hole drilled by the drilling machine.

17. A method as claimed in claim 16, wherein processing the plurality of distance readings includes determining a first average of the plurality of distance readings.

18. A method as claimed in claim 17, wherein processing the plurality of distance readings includes determining a standard deviation of the plurality of distance readings.

19. A method as claimed in claim 18, wherein processing the plurality of distance readings includes determining a range of acceptable distance values based on the first average and the standard deviation.

20. A method as claimed in claim 19, wherein processing the plurality of distance readings includes determining a subset of the plurality of distance readings, the subset including distance readings that include a distance value in the range of acceptable distance values.

21. A method as claimed in claim 20, wherein processing the plurality of distance readings includes determining a second average of the subset to determine the calculated distance.

22. A controller for a drilling machine, the controller comprising:
a laser range finder interface;
a stop-count-logic-in module;
a carousel-logic-in/out module;
a deceleration-logic module;
a target-depth-logic-out module;
a rod support logic-in/out module; and
a pipe-in-the-hole-logic-out module.

23. A controller as claimed in claim 22, wherein the laser range finder interface is configured to obtain a plurality of distance readings from a laser range finder, each of the plurality of distance readings including a distance value between the laser range finder and a rotary head of the drilling machine.

24. A controller as claimed in claim 23, wherein the laser range finder interface is further configured to process the plurality of distance readings to produce a calculated distance between the laser range finder and the rotary head of the drilling machine.

25. A controller as claimed in claim 24, wherein the laser range finder interface is further configured to determine a first average of the plurality of distance readings.

26. A controller as claimed in claim 25, wherein the laser range finder interface is further configured to determine a standard deviation of the plurality of distance readings.

27. A controller as claimed in claim 26, wherein the laser range finder interface is further configured to determine a range of acceptable distance values based on the first average and the standard deviation.

28. A controller as claimed in claim 27, wherein the laser range finder interface is further configured to determine a subset of the plurality of distance readings, the subset including distance readings that include a distance value in the range of acceptable distance values.

29. A controller as claimed in claim 28, wherein the laser range finder interface is further configured to determine a second average of the subset.

30. A controller as claimed in claim 23, wherein the laser range finder interface is further configured to use the second average to determine the calculated distance.

31. A controller as claimed in claim 22, wherein the stop-count-logic-in module is configured to stop and start a count of drill rods included in a drill string of the drilling machine.

32. A controller as claimed in claim 31, wherein the stop-count-logic-in module is further configured to obtain outputs from at least one of a wrench controller and a rotation controller and to determine if a drill rod is being added to the drill string of the drilling machine.

33. A controller as claimed in claim 22, wherein the deceleration-logic module is configured to initiate deceleration of the rotary head of the drilling machine.

34. A controller as claimed in claim 22, wherein the target-depth-logic-out module is configured to indicate when a hole drilled by the drilling machine reaches a target depth.

35. A controller as claimed in claim 34, wherein the target-depth-logic-out module is further configured to stop a drilling operation of the drilling machine once the hold drilled by the drilling machine reaches the target depth.

36. A controller as claimed in claim 22, wherein the carousel-logic-in/out module is configured to initiate operation of a feed pressure system.

37. A controller as claimed in claim 36, wherein the carousel-logic-in/out module is further configured to initiate operation of the feed pressure system when a carousel extension system indicates that a carousel is extended from a stowed position.

38. A controller as claimed in claim 22, where the pipe-in-the-hole-logic-out module is configured to restrict movement of the drilling machine when a drill string of the drilling machine is still in a hole.

39. A controller as claimed in claim 22, wherein the rod-support-logic-in/out module is configured to automatically move a rod swung into a position that interferes with movement of a rotary head of the drilling machine.

40. A controller as claimed in claim 22, wherein the rod-support-logic-in/out module is configured to automatically stop movement of a rotary head of the drilling machine if a rod is swung into a position that interferes with movement of the rotary head.

41. A controller as claimed in claim 22, further comprising a modem interface configured to transmit data to a modem.

42. A computer-readable medium including instructions for determining a depth of a hole drilled by a drilling machine, the instructions including:
obtaining a plurality of distance readings from a laser range finder, each of the plurality of distance readings including a distance value between the laser range finder and a rotary head of the drilling machine;
processing the plurality of distance readings to produce a calculated distance between the laser range finder and the rotary head of the drilling machine; and
using the calculated distance and the length of a drill string of the drilling machine to determine the depth of the hole drilled by the drilling machine.

43. A computer-readable medium as claimed in claim 42, further comprising instructions for determining a first average of the plurality of distance readings.

44. A computer-readable medium as claimed in claim 43, further comprising instructions for determining a standard deviation of the plurality of distance readings.

45. A computer-readable medium as claimed in claim 44, further comprising instructions for determining a range of acceptable distance values based on the first average and the standard deviation.

46. A computer-readable medium as claimed in claim 45, further comprising instructions for determining a subset of the plurality of distance readings, the subset including distance readings that include a distance value in the range of acceptable distance values.

47. A computer-readable medium as claimed in claim 46, further comprising instructions for determining a second average of the subset.

48. A computer-readable medium as claimed in claim 47, further comprising instructions for using the second average to determine the calculated distance between the laser range finder.

49. A method of calibrating a laser range finder for a drilling machine, the method comprising:
attaching the laser range finder to the drilling machine;
aiming the laser range finder at a rotary head of the drilling machine;
positioning the rotary head of the drilling machine at a predetermined position;
signaling the laser range finder that the rotary head is at the predetermined position; and
calibrating the laser range finder with the rotary head at the predetermined position.

50. A method as claimed in claim 49, wherein the predetermined position includes a top position of the rotary head where the rotary head is closest to the laser range finder.

51. A method as claimed in claim 49, wherein the predetermined position includes a bottom position of the rotary head where the rotary head is furthest from the laser range finder.

52. A method as claimed in claim 49, wherein signaling the laser range finder includes selecting a button on the laser range finder.

53. A method as claimed in claim 49, wherein signaling the laser range finder includes holding the rotary head at the predetermined position for a predetermined amount of time.

54. A method as claimed in claim 49, further comprising providing a known distance between the rotary head and the laser range finder when the rotary head is at the predetermined position to the laser range finder.

55. A method as claimed in claim 54, wherein calibrating the laser range finder includes comparing a calculated distance to the known distance.

56. A method as claimed in claim 55, wherein calibrating the laser range finder includes adjusting the calculated distance to be generally equal to the known distance.

57. A method as claimed in claim 49, further comprising positioning the rotary head at another predetermined position.
